(19) United States
(12) Patent Application Publication
(10) Pub. No.: US 2002/0143573 A1
(43) Pub. Date: Oct. 3, 2002

(54) Integrated automated recruiting management system

(76) Inventors: John M. Bryce, Blacksburg, VA (US); Philip Kedy, Blacksburg, VA (US); Malvin Seale, Blacksburg, VA (US)

Correspondence Address: Richard C. Litman, LITMAN LAW OFFICES, LTD., P.O. Box 15035, Arlington, VA, 22215, US

(21) Appl. No.: 10/113,565

(22) Filed: Apr. 2, 2002

Related U.S. Application Data
(60) Provisional application No. 60/280,751, filed on Apr. 3, 2001.

(51) Int. Cl. G06F 17/60

(52) U.S. Cl. 705/1

(57) ABSTRACT

The integrated automated recruiting management system has three main components: a criteria matching application for matching a job seeker's skills and qualification's with those required by a job posting; a message center server and downloadable client for providing a recruiter with a way of communicating particular screening questions to a job seeker and receiving a response in text, audio or video; and a web-based job recruiter application for providing an Internet web site accessible to job recruiters and job seekers and for coordinating the first two components. The system permits a recruiter to post a detailed job posting, receives job seeker applications, ranks and sorts candidates according to skills and qualifications, automatically queries job seeker references, communicates recruiter questions to job seekers and receives responses, including audio and video, provides the recruiter with a package of the information collected, and automated tools for scheduling interviews.

### CROSS-REFERENCE TO RELATED APPLICATION

This application claims the benefit of U.S. Provisional Patent Application Serial No. 60/280,751, filed Apr. 3, 2001.

### BACKGROUND OF THE INVENTION

1. Field of the Invention

The present invention relates to computerized business systems and methods, and particularly to an integrated automated recruiting management system having a criteria matcher software program for matching job candidates with job openings, a message center permitting job candidates to record responses to recruiter questions with streaming audio and video, and a web-based software program integrating the applications and providing recruiters with access to system resources.

2. Description of Related Art

Traditionally employers and job seekers have looked to classified advertisements in the newspaper and to employment agencies as a means of matching job seekers to job openings. The process has usually entailed the employer reading and sifting through candidate resumes to narrow the field to a few candidates, followed by prescreening applicants via telephone and inviting the most likely prospects to come in for a job interview. With the advances in electronic communications, employers and job seekers have sought to increase their options through job postings on the Internet. The postings may be made on the employer's web site, or through a brief advertisement on a bulletin board. Resumes are submitted to the employer by facsimile, paper, the web, or by e-mail. There are some software tools for screening resumes; however, most of these tools only sort the resumes by job title, or scan the resumes for a few keywords, without ranking the job candidates by job skills, interest, experience, and other relevant qualifications. Efforts to incorporate video or audio into the recruiting process have generally not advanced beyond the developmental stage.

A problem with existing job recruiting methods is that they are still based on the traditional job advertisement, which is usually limited in length due to the cost of advertising and limited space on bulletin boards. A further problem is that resumes submitted by job seekers are generally generic, and not tailored to a specific job opening, and may be broadly written with the relevant information buried in fluff, consequently requiring many man hours to review. A third problem is that the sorting and ranking of applications must be done manually, and is not automated. A fourth problem is that resumes are often formal, polished documents, and do not provide the recruiter with any information of the job seeker's ability to respond to questions or problems on the spot. A fifth problem is that existing recruiting systems do not integrate automated processes for obtaining the job seeker's references or for scheduling interviews.

There is therefore a need for a integrated automated recruiting management system which features an integrated, online system for posting job openings, accepting applications, ranking the most qualified job candidates, incorporating a job candidate's timed responses, which may be in a variety of formats, including text, numeric, audio or audio/video format, to a recruiter's prescreening questions, providing automated processes for contacting the job seeker's references, can be integrated with other enterprise management systems, and automated processes for scheduling job interviews, both face-to-face and real time. Some patents show some of the features of the present integrated automated recruiting management system, but none shows or suggests the particular combination of features in the present invention.

U.S. Pat. No. 5,918,207, issued Jun. 29, 1999 to McGovern et al., shows a process and system wherein a service provider predict's a customer's technology needs and uses software to compare the skills of candidates with the customer's technology needs for predictive resource planning. U.S. Pat. No. 5,978,767, issued Nov. 2, 1999 to Chriest et al., describes a career development tool used over a network. The user selects a skill and the network provides a career description for which the skills are relevant. It may be used in developing a curriculum.

U.S. Pat. No. 5,978,768, issued Nov. 2, 1999 to McGovern et al., teaches a method and system permitting a company to advertise job openings on the Internet and to receive resumes directly, and sorts the resumes by position applied for. U.S. Pat. No. 6,049,776, issued Apr. 11, 2000 to Donnelly et al., describes a system which maintains information on an employee's skills, calendar, and projects on a database. The system matches the employee's skills and availability to new projects.

U.S. Pat. No. 6,070,143, issued May 30, 2000 to Barney et al., shows a networked system which allows access to a master database of job description skills and abilities and access to a products database and survey program to customize job analysis. U.S. Pat. No. 6,121,963, issued Sep. 19, 2000 to C. J. Ange, teaches a method of displaying a multimedia file as an integrated part of a graphical web page, rather than through a pop-up window.

U.S. Pat. No. 6,131,121, issued Oct. 10, 2000 to Mattaway et al., describes a software utility for establishing point-to-point links with and between temporary IP addresses and dynamically allocated IP addresses which are sufficient to support the transfer of real time audio and video.

None of the above inventions and patents, taken either singly or in combination, is seen to describe the instant invention as claimed.

### SUMMARY OF THE INVENTION

The integrated automated recruiting management system has three main components: a criteria matching application for matching a job seeker's skills and qualification's with those required by a job posting; a message center server and downloadable client for providing a recruiter with a way of communicating particular screening questions to a job seeker and receiving a response in text, audio or video; and a web-based job recruiter application for providing an Internet web site accessible to job recruiters and job seekers and for coordinating the first two components. The system permits a recruiter to post and distribute a detailed job posting, receives job seeker applications, ranks and sorts candidates according to skills and qualifications, automatically queries job seeker references, communicates recruiter questions to job seekers and receives responses, including audio and video, provides the recruiter with a package of the information collected, and automated tools for processes such as scheduling interviews, communicating with candidates, and making decisions.

Accordingly, it is a principal object of the invention to provide an integrated automated recruiting management system which uses an online application to automate the recruiting process and increase efficiency.

It is another object of the invention to provide an integrated automated recruiting management system which has a software application which matches a job seeker's skills and qualifications with a recruiter's job posting, and ranks and sorts a plurality of job seeker applications.

It is a further object of the invention to provide an integrated automated recruiting management system which permits a recruiter to pose prescreening questions to a job seeker and receive a response in text, audio or video.

Still another object of the invention is to provide an integrated automated recruiting management system which automates routine job recruiter functions, such as contacting job seeker references and notifying job seekers of scheduled job interviews.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is block diagram of an online application process architecture in an integrated automated recruiting management system according to the present invention.

FIGS. 2A and 2B are block diagrams showing a network environment of back-end servers for the integrated automated recruiting management system according to the present invention.

FIGS. 3A and 3B are block diagrams showing the architecture of a web-based job recruiter program for the integrated automated recruiting management system according to the present invention.

FIG. 4 is a block diagram showing the architecture of a criteria matching application in the integrated automated recruiting management system according to the present invention.

FIG. 5 is a block diagram of a message center client in the integrated automated recruiting management system according to the present invention.

FIG. 6 is a block diagram of a message center server in the integrated automated recruiting management system according to the present invention.

FIG. 7 is a flowchart showing operation of a message center client at application startup in the integrated automated recruiting management system according to the present invention.

FIG. 8 is a flowchart showing message center individual question interaction in the integrated automated recruiting management system according to the present invention.

FIG. 9 shows a flowchart of message sender server operation in sending questions in the integrated automated recruiting management system according to the present invention.

FIG. 10 shows a flowchart of message sender server operation in receiving answers to questions in the integrated automated recruiting management system according to the present invention.

FIG. 11 shows a block diagram of a typical computer system for use in the integrated automated recruiting management system according to the present invention.

Similar reference characters denote corresponding features consistently throughout the attached drawings.

### DETAILED DESCRIPTION OF THE PREFERRED EMBODIMENTS

The present invention is an integrated automated recruiting management system which provides an integrated online approach to the problem of recruiting job seekers for particular job postings. The system employs three major components: a criteria matching application for matching a job seeker's skills and qualification's with those required by a job posting; a message center server and downloadable client for providing a recruiter with a way of communicating particular screening questions to a job seeker and receiving a response in text, audio or video; and a web-based job recruiter application for providing an Internet web site accessible to job recruiters and job seekers and for coordinating the first two components.

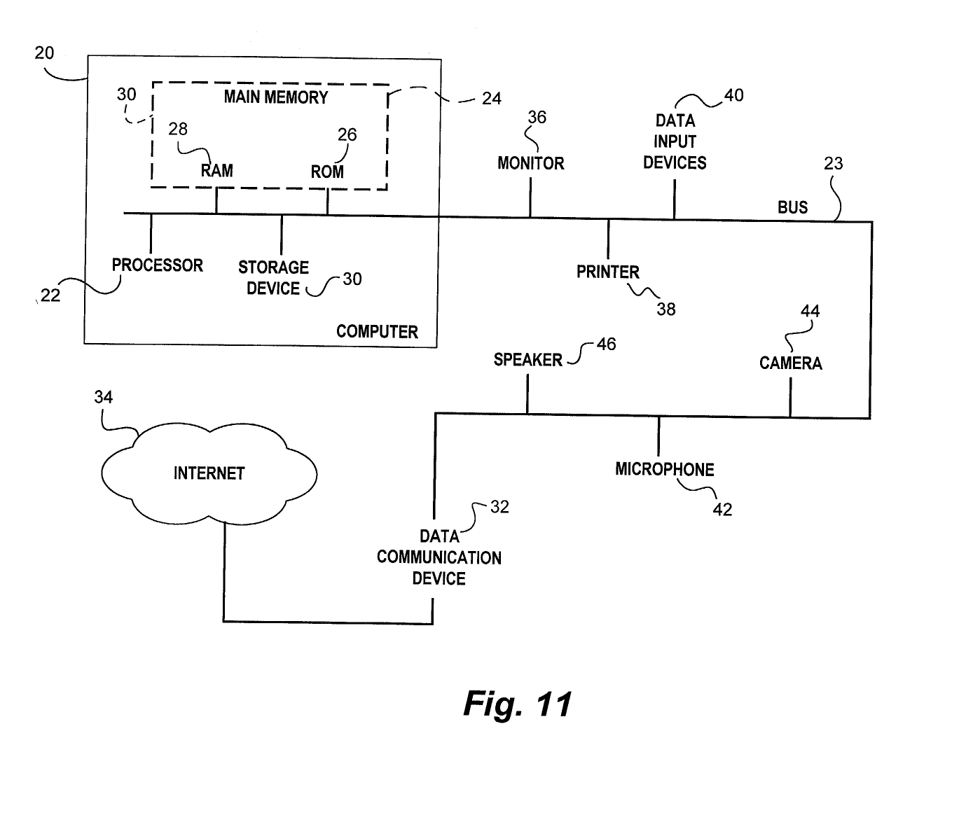

The system is designed to operate on one or more computers. While mainframes or minicomputers may be used, the system performs quite adequately using personal computers systems. While the details on the computer system may vary and still be within the scope of the claimed invention, FIG. 11 shows a typical personal computer system for carrying out the present invention.

The personal computer system is a conventional system which includes a personal computer 20 having a microprocessor 22 (viz., an Intel Pentium III), including a central processing unit (CPU), a sequencer, and an arithmetic logic unit (ALU), connected by a bus 23 or buses to an area of main memory 24 for executing program code under the direction of the microprocessor 22, main memory including read only memory (ROM) 26 and random access memory (RAM) 28. The personal computer 20 also has a storage device 30 and a data communications device 32, such as a modem or other means for connecting to a network 34 such as Ethernet, ISDN, DSL, or other devices for connecting to a network 34, and particularly to the Internet either directly or through an Ethernet or LAN, preferably using a high speed connection, such as T3, ISDN, or DSL.

The personal computer system also comprises peripheral devices, such as a display monitor 36, a printer 38, and one or more data input devices 40 such as a keyboard or mouse. Client computers, particularly those used by job seekers, will also be equipped with multimedia transducers, such as a microphone 42, video camera 44, and speaker 46 in order to record and/or playback audio and video.

It will be understood that the term storage device 30 refers to a device or means for storing and retrieving data or program code on any computer readable medium, and includes a hard disk drive, a floppy drive or floppy disk, a compact disk drive or compact disk, a digital video disk (DVD) drive or DVD disk, a ZIP drive or ZIP disk, magnetic tape and any other magnetic medium, punch cards, paper tape, memory chips, or any other medium from which a computer can read.

The client personal computer 20 will be equipped with a web browser, such as Netscape Navigator, Microsoft's Internet Explorer, or other browser software executing in main memory, while server computers will be equipped with web server software capable of delivering web pages in hypertext markup language (HTML) to client computers using hypertext transfer protocol (HTTP).

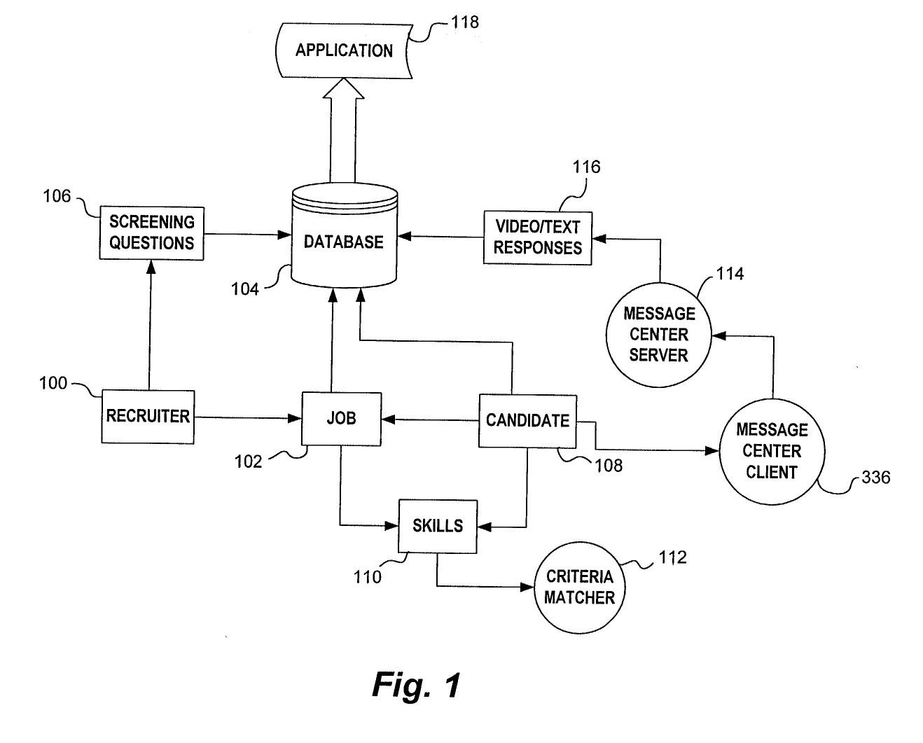

FIG. 1 shows an overall diagram of an online application process architecture in an integrated automated recruiting management system according to the present invention. A recruiter 100 enters recruiter information and job detail relating to a particular job 102 into a database 104. The recruiter may also frame particular screening questions 106 and enter the screening questions into the database 104. The candidate 108 for the job 102 enters candidate information into the database 104, including the candidate's skills particularly suited for the job 102. The skills data 110, including the recruiter supplied information regarding the skills required by the job opening and the candidate's description of his/her skills are input to a criteria matching software application 112, which calculates the number of years experience a candidate has in a particular skill and matches that against the skill required by the job 102, and calculates a percentage match to help recruiters find a good match.

The candidate 108 may provide responses, including video, to the recruiter's screening questions through a message center client 336. The message center client 336 uploads the responses to the message center server 114, which records video and/or text responses 116 in the database 104. The resulting information in the database is extracted to form a completed job application 118 for review by the recruiter 100.

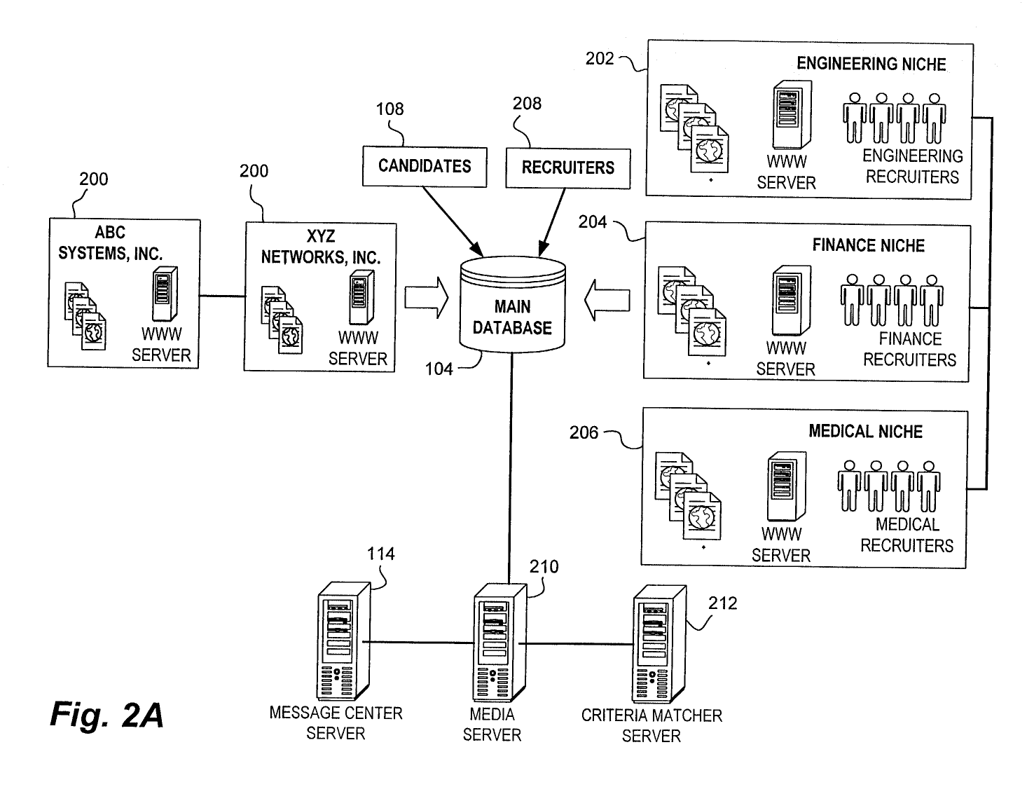

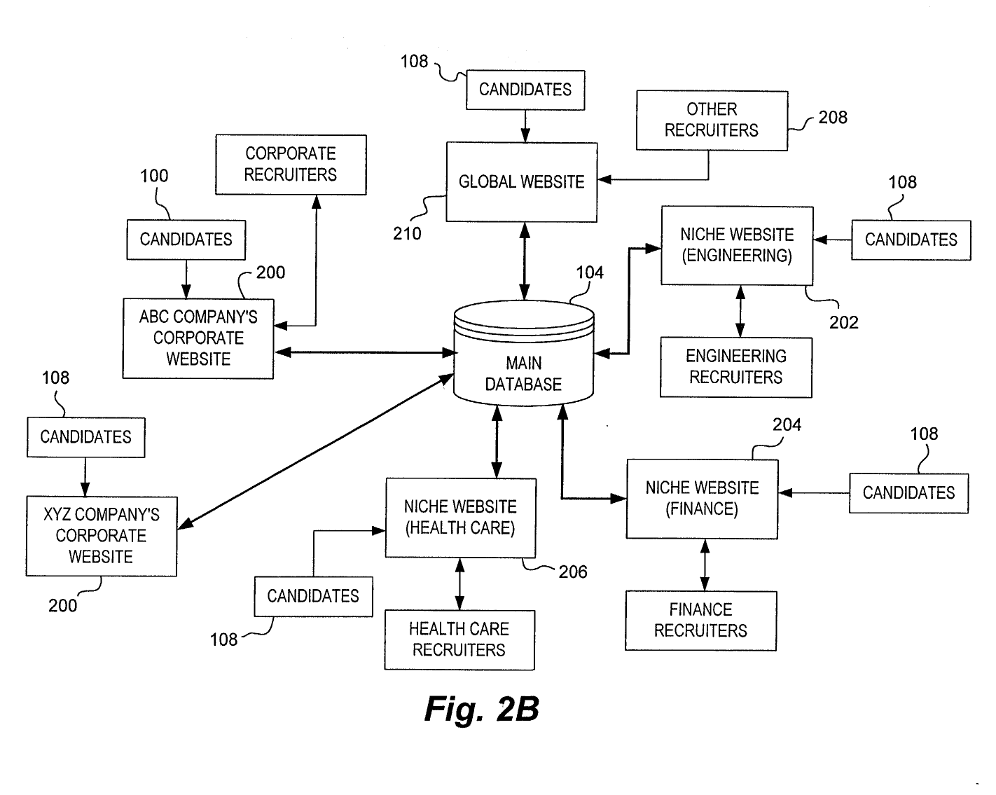

FIGS. 2A and 2B show a network environment of back-end servers for the integrated automated recruiting management system. An aggregate collection of corporate websites 200 running system software that permits job postings on the corporate website is connected to the system's main database 104. In addition, various niche websites created with the system software and which target recruiters in their specialty areas, such as engineering 202, finance 204, medicine and health care 206, etc. are also linked to the main database 104. Candidates 108 and other job recruiters 208 may also access the main database 104. The main database 104 also receives data from a message center server 114, a media server 210, and a criteria matching server 212. Thus candidates 108 and recruiters 100 may access the system through corporate websites 200, niche websites 202, 204, and 206, or directly through the system's main or global website 210.

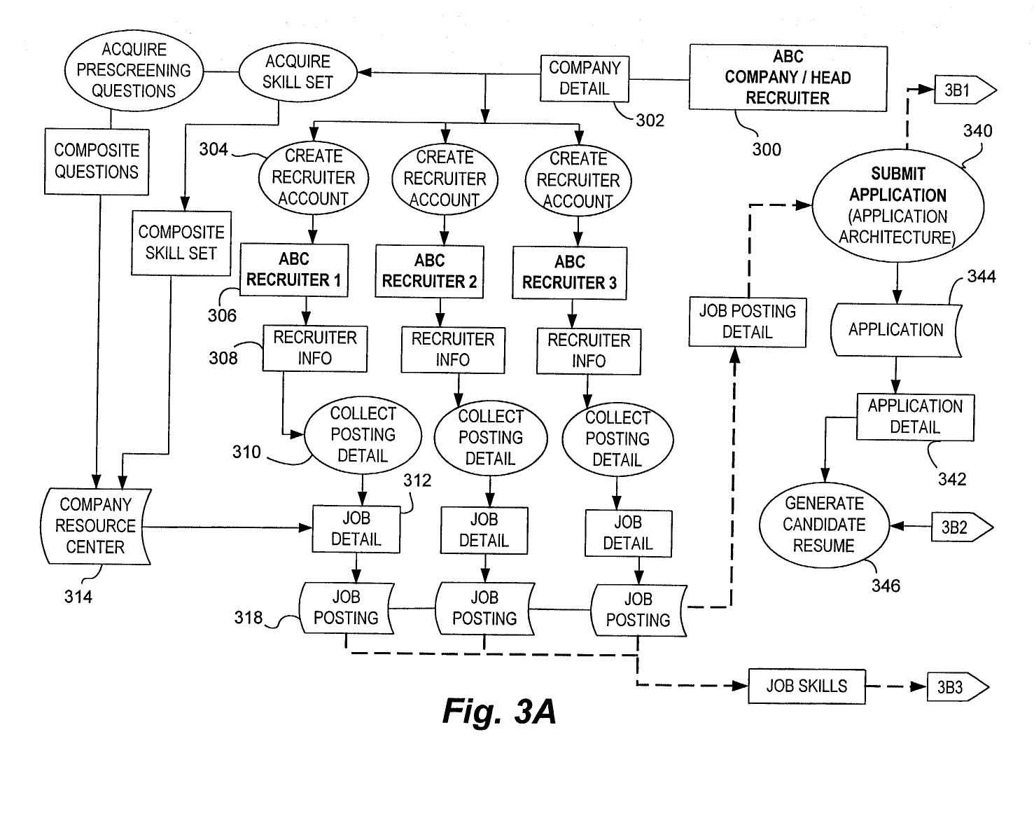

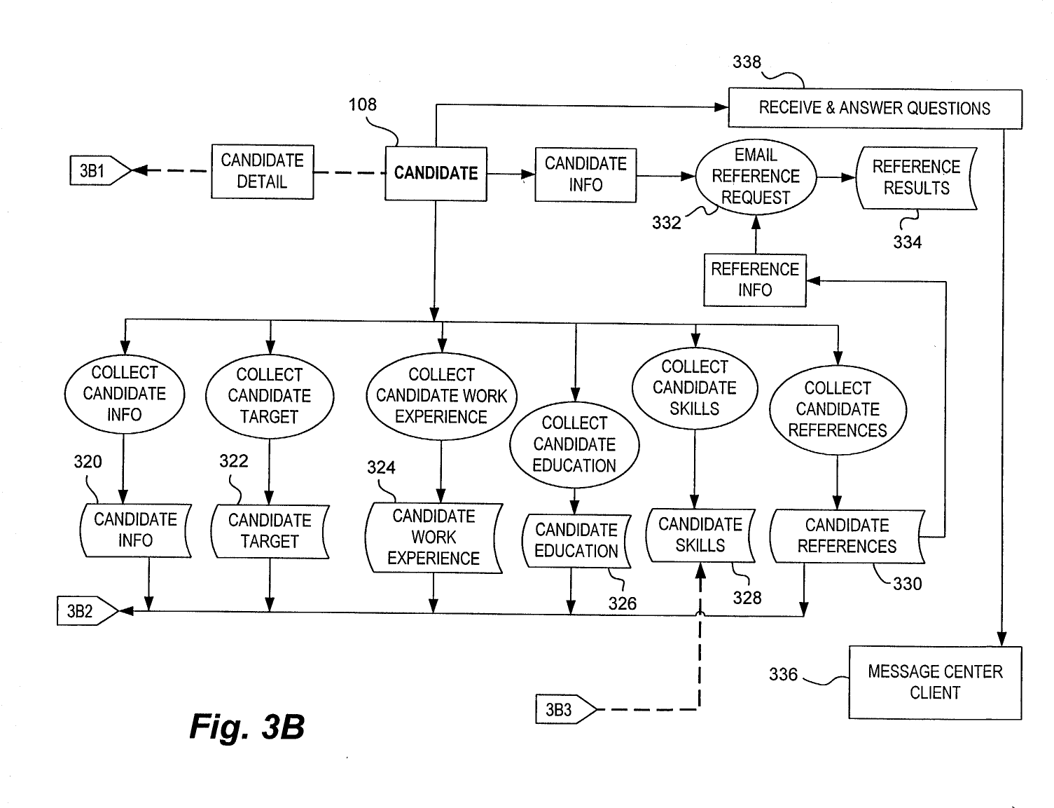

The front end of the system is a web-based job recruiter program, described with reference to FIGS. 3A and 3B. The program is made using HTML, JavaScript, and server-side scripting languages, combined with a relational database server. Recruiters can log into the system from anywhere that has a working Internet connection. Once logged in, a recruiter can perform various actions depending on the level of clearance they have. Such actions include: managing a personal or company profile, adding/deleting other recruiter accounts to give additional recruiters with the company access to the system, creating/managing job postings, viewing information about candidates (profiles, video/audio clips, text responses to pre-screening questions, etc.) and editing/extracting commonly used skills, pre-screening questions, job descriptions, etc. from a company resource center.

More particularly, a company or head recruiter 300 may provide a company profile registration 302, registering their location as well as web site and contact information, vision and mission statements. The company/head recruiter 300 may then create a plurality of recruiter accounts 304 for different company department recruiters, so that each company recruiter 306 may post their own job openings and evaluate candidates responding to the postings. Contact information 308 is stored for each recruiter 306.

Once registered, the application collects posting details 310. The recruiter supplies job details 312, such as location, salary range, position type, job description, and the number of desired positions. In addition, the recruiter can specify prescreening questions they wish to have the candidate answer and the desired skills associated with the job posting. For this purpose, the recruiter 306 may avail himself of a library of general or standardized company prescreening questions, job descriptions, and skill sets which the company has previously saved to the company resource center 314. The job details 312 are collected via HTML forms and saved in the main database 104, in order to facilitate automatic preparation of candidate profile forms. Once the job details 312 have been collected, the job posting 318 is published on the corporate website, as well as any niche websites in the network, and the system's website.

A candidate 108 reviews the job postings 318 and may elect to initiate the application process by clicking an appropriate button. The web-based job recruiter program provides the candidate 108 with a series of HTML forms for preparing a candidate profile. The responses to each question on the form may be collected by the server using a scripting language and saved in the database 104. Consequently, it is unnecessary to scan resumes for keywords.

The candidates provide general candidate information 320, such as name, address, e-mail address, etc. The candidates also provide their target information 322 (career goals), work experience 324, education 326, skills 328, and references 330, including an e-mail address for each reference. The system can then automatically e-mail a request for a reference 332 to the persons listed as references by the candidate 108. The results 334 of the reference request can then be stored in the database 104.

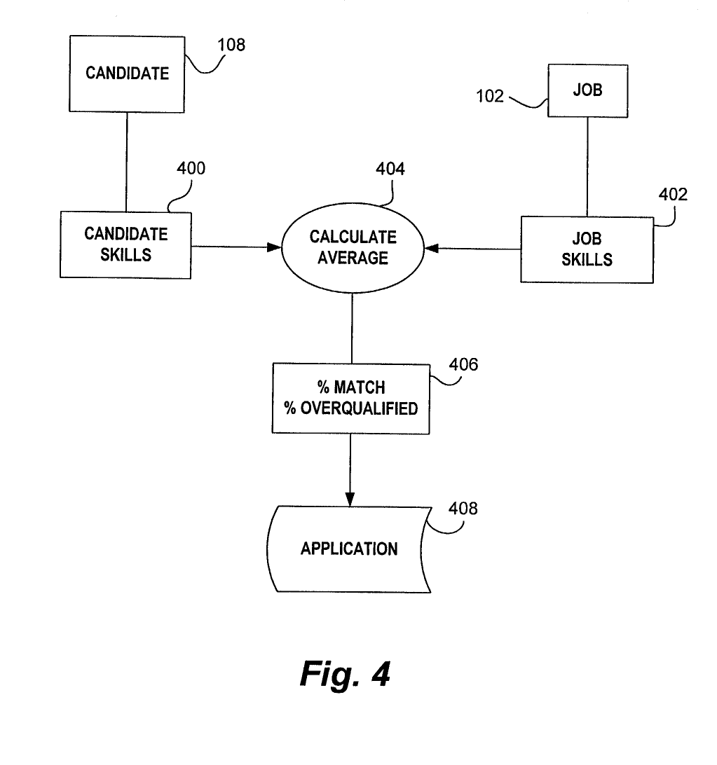

The web-based job recruiter program inputs the candidate's 108 responses to the candidate profile questions regarding the candidate's skills 400 and the recruiter's description of the job 102 and the job skills 402 required to the criteria matching program 112. As outlined in FIG. 4, the criteria matching program matches the candidate's skills 400 and the job skills 402 and calculates averages 404, including the percentage of matches found 406 and the percentage degree of the candidate's overqualification. These results are stored and incorporated as part of the candidate's application at 408. The criteria matching application 112 incorporates mathematical algorithms and is written in a high level programming language. It offers the advantage of speed and an automated approach to evaluating the candidate's eligibility. The skills may be weighted at the option of the recruiter in outlining the job skills required, as well as the weight to be ascribed to experience, education, and Boolean and numeric candidate responses. The techniques in retrieving the skills data from the database 104 and calculating averages and percentage match are conventional, and will not be described further.

Referring back to FIG. 3B, the candidate 108 is instructed by the web-based job recruiter program to download a software program referred to as a message center client 336 which may be loaded onto the candidate's client computer and which provides a means through which the candidate 108 may receive and answer the recruiter's prescreening questions 338.

The message center client 336 is preferably made using Windows Media application programming interfaces (APIs). The program interfaces with the operating system and computer hardware to automatically detect any attached audio/video recording devices. The program is built with a high level programming language, such as C++. The rate of encoding media streams is set to accommodate all users on various network connections. The message center client 336 software allows the candidate 108 to perform two major functions: (1) to capture, compress, and upload video, audio, and text, numeric or Boolean responses; and (2) to manage their job search by keeping track of their outstanding and previously processed applications, pre-screening questions, real interviews, etc. Candidates are notified by e-mail when they should run their client 336 and log in to the message center server 114 for new messages. The message center client 336 also provides that the candidate 108 must answer certain recruiter questions within a specified period after download.

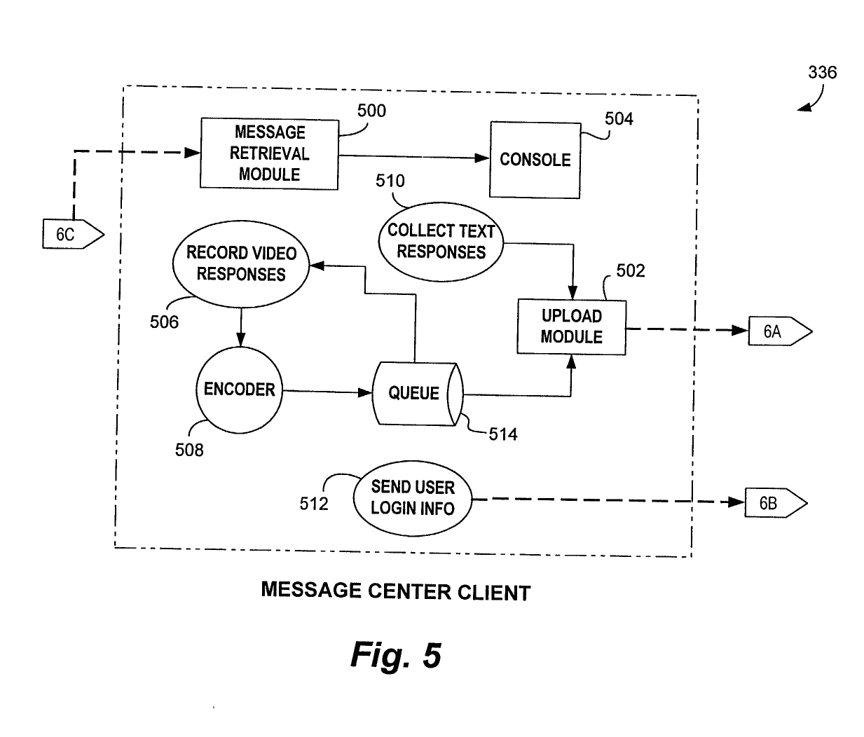

FIG. 5 shows a block diagram of the software modules and applications included with the message center client 336. The client 336 includes a message retrieval module 500 for retrieving messages from the message center server 114, an upload module 502 for uploading responses to the message center server 114, and a console module 504 for displaying messages and entering responses. The client 336 further includes applications which record video responses 506, encode the video or audio responses 508 through external applications, collect text responses 510, and send user login information 512 to the message center server 114. The client 336 also includes a queue 514 for queuing streaming audio and video files.

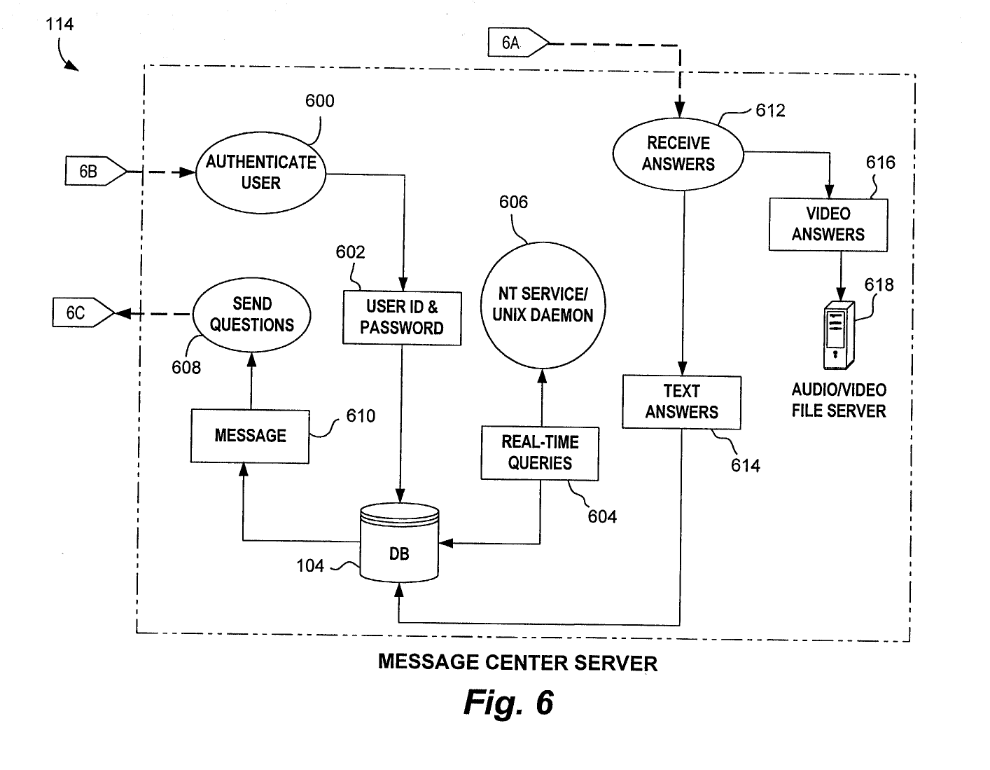

FIG. 6 shows a block diagram of the message center server 114. The message center server 114 includes an application which authenticates the user 600 by sending a query regarding the user's ID and password 602 to the relational database 104 to verify the candidate's identity as recorded when the candidate logged in to the web-based job recruiter application. The server 114 may receive real time queries 604 from a recruiter through a Windows NT Service or a UNIX Daemon 606, records the query in the database 104 and uses another application to send questions 608 and other messages 610 to the message center client 336. The message center server 114 includes an application which receives answers 612 from the message center client 336, records text answers 614 in the database 104, and routes video answers 616 into an audio/video file server 618.

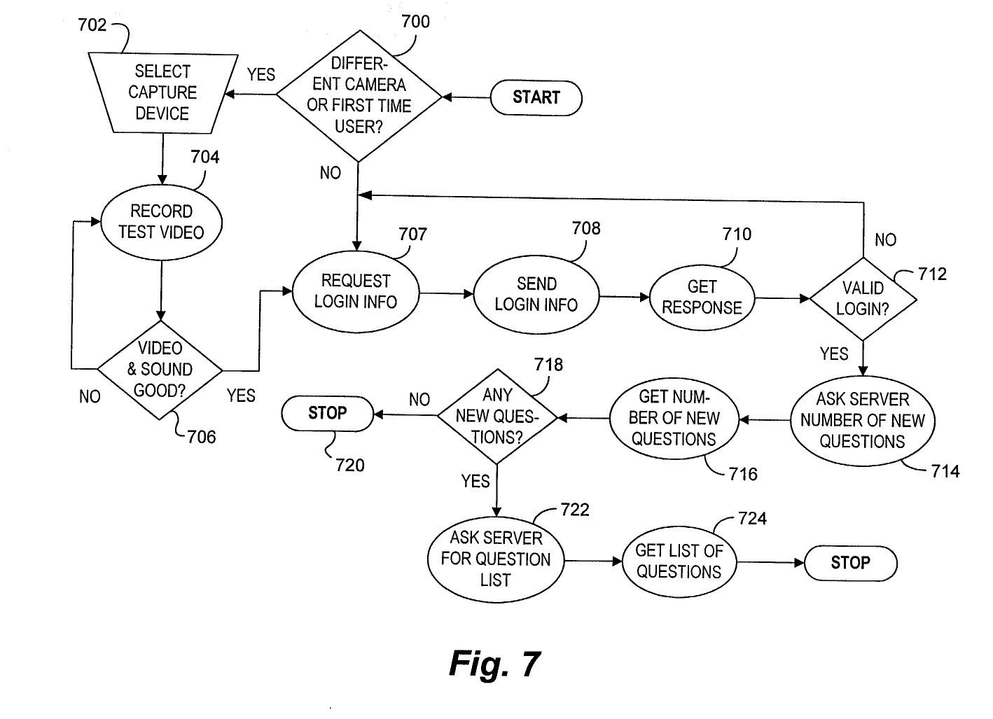

FIG. 7 shows a flowchart of the message center client 336 software at startup. At startup, the application tests to see if a new camera is installed 700. If so, the application allows the user to select the capture device 702 and the candidate 108 records a test video 704. The application tests to see if the audio and video quality are good 706. If not, the candidate may make adjustments and repeat the test 704, otherwise the application requests the candidate to enter login information 707 and sends the login information 708 to the message center server 114 and gets a response 710 from the server. The application tests to see if the login was accepted 712. If not, the login procedure is repeated at 707, otherwise the application asks the server 114 for the number of new questions 714 and receives the response 716 from the server. The application tests to see if there are any new questions 718. If there are no new questions, the application stops 720, otherwise the application requests the server to provide the list of questions 722 and receives the list 724.

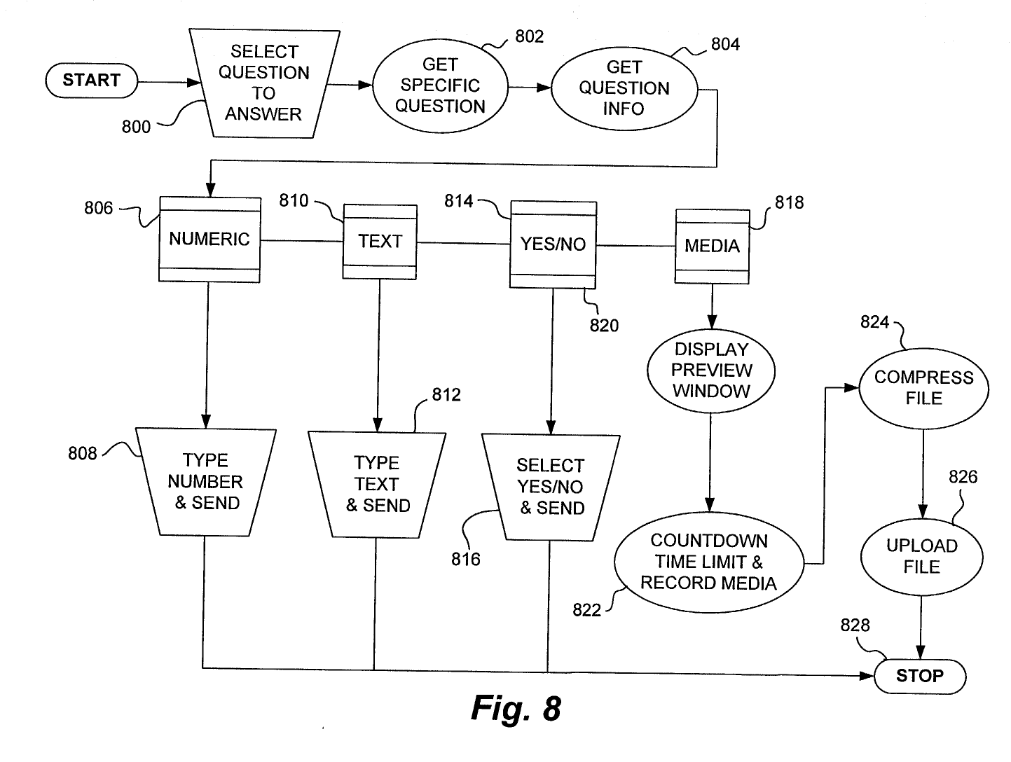

FIG. 8 shows a flowchart of the message center client 336 software during individual question interaction. When the candidate 108 selects a question to answer 800, the client 336 gets a specific question 802 and specific question information 804, including the mode of response requested. If the question calls for a numeric response 806, the candidate types the number and sends the response 808. If the question calls for a text response 810, the candidate types the text and sends the response 812. If the question calls for a yes or no response 814, the candidate selects yes or no via a checkbox or the like and sends the response 816. If the question calls for a media response 818, whether audio or video, the application displays a preview window 820 and the candidate records the response while a countdown timer runs 822. When the candidate stops recording or the timer runs out, the file is compressed 824, uploaded to the server 826, and the process stops 828.

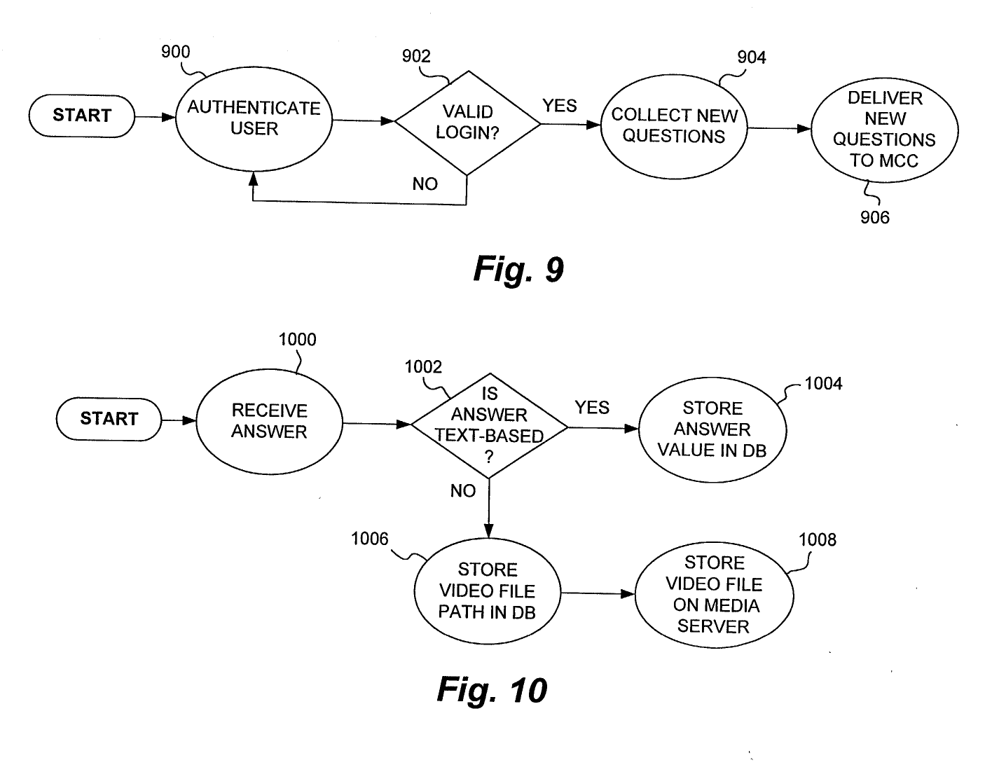

FIG. 9 shows a flowchart of message center server 114 response when a client attempts a login using the message center client 336. The server authenticates the user 900 and tests to see if the login is valid 902. If so, the server collects the questions 904 and delivers the questions to the message center client 906.

FIG. 10 is a flowchart of message center server 114 response when answers to questions are received. The server receives the answer 1000 and tests to see if the answer is text-based 1002. If so, the text-based answer is stored 1004 in the database 104. If the answer is an audio or video file, the path to the audio/video file is stored 1006 in the database 104, and the video file is stored 1008 on the media file server 618.

Referring back to FIG. 3A, when the candidate elects to submit the application 340, the candidate's responses to the profile questions via the web-based job recruiter application and the candidate's response to the recruiter's prescreening questions via the message center client and server provide the application detail 342 which is saved as the client application 344. The application detail may be used to generate a conventional candidate resume 346 if desired. In any event, the application is saved.

When the recruiter 306 enters the job posting 318, the recruiter 306 has the option of requesting that the system notify him/her by e-mail when candidate applications are received. In any event, when the recruiter 306 next logs into the system, the web-based job recruiter application provides the recruiter the option of viewing the candidates for the job posting. The application provides the recruiter 306 with a list of candidates ranked and sorted according to percentage match. The recruiter 306 may select a particular candidate from the list and view the candidate's profile information in text format, as well as the candidate's response to pre-screening questions via text or streaming video.

At this point, the recruiter 306 has several options. The recruiter 306 may place the candidate on a remembered list, meaning that the candidate meets the minimum qualifications, but no decision has been reached. The recruiter 306 may elect to discard the candidate, meaning that the candidate will be eliminated from the list of candidates being considered for the position.

The recruiter 306 also has the option to pose further prescreening questions to a particular candidate, or the recruiter 306 may decide to invite the candidate 108 for an interview. In the latter event, the recruiter 306 may provide his interview schedule to the system. An invited candidate can then select an available time and interview location. The candidate's response is reflected in the recruiter's scheduling system, and the recruiter's confirmation is likewise forwarded to the candidate 108.

Consequently, the integrated automated recruiting management system of the present invention provides a convenient, automated tool both for job recruiters and job seekers.

It is to be understood that the present invention is not limited to the sole embodiments described above, but encompasses any and all embodiments within the scope of the following claims.

We claim:

1. An integrated automated recruiting management system, comprising:
(a) at least one server computer having a processor, an area of main memory for executing program code under the direction of the processor, a storage device for storing data and program code, and a bus connecting the processor main memory and the storage device;
(b) at least one relational database stored on said storage device;
(c) a data communications device connected to said bus for connecting said server computer to the Internet; and
(d) a web-based job recruiting computer program code stored in said storage device and executing in said main memory under the direction of said processor, the computer program including:
(i) web server software means for publishing at least one web site on the Internet;
(ii) means for accepting at least one job posting from at least one job recruiter through said web site, the job posting including detailed job skills and experience required from a candidate;
(iii) means for publishing the at least one job posting on the web site;
(iv) means for receiving at least one candidate profile through said web site, including form questions regarding the candidate's skills and experience;
(v) means for conveying at least one prescreening question posed by the job recruiter to the candidate, including a requirement for a video response;
(vi) means for receiving and storing a video file from the candidate in response to the at least one prescreening question; and
(vii) means for transferring the video file to the job recruiter through the Internet as streaming video.

2. The integrated automated recruiting management system according to claim 1, further comprising a main database for storing job postings and candidate profiles, said main database being accessible through said at least one web site.

3. The integrated automated recruiting management system according to claim 2, wherein said web server software means comprises:
(a) means for publishing a main web site on the Internet, said main web site accepting job postings from multiple employers and job recruiters, and for multiple job disciplines;
(b) means for publishing a corporate web site on the Internet, said corporate web site accepting job postings from multiple job recruiters within said corporation and accepting candidate profiles directly, said corporate web site having means for duplicating job postings onto said main web site and accessing candidate profiles stored in said main database; and
(c) means for publishing a niche web site on the Internet, said niche web site accepting job postings from multiple job recruiters within a particular job discipline and accepting candidate profiles directly, said niche web site having means for duplicating job postings onto said main web site and accessing candidate profiles stored in said main database.

4. The integrated automated recruiting management system according to claim 1, further comprising:
(a) a message center server; and
(b) a message center client program downloadable from said web site in order to establish a message center client on a candidate's computer, said message center client program having:
(i) means for logging into said message center server;
(ii) means for detecting audio and video recording devices attached to a candidate's computer;
(iii) means for capturing, compressing, and uploading to said message center server video, audio, text, numeric and Boolean responses to a job recruiter's question; and
(iv) means for timing the candidate's responses to the job recruiter's question.

5. The integrated automated recruiting management system according to claim 1, further comprising:
(a) means for extracting a candidate's responses to the form questions on said candidate's profile; and
(b) a criteria matching program having:
(i) means for comparing the candidate's job skills responses to the job skills in the job posting;
(ii) means for computing a percentage of matches between a candidate's job skills responses and the job skills required in the job posting; and
(iii) means for computing a percentage of a candidate's overqualification.

6. The integrated automated recruiting management system according to claim 1, further comprising:
(a) means for automatically requesting a letter of reference by electronic mail from a candidate's listed references on the candidate profile; and
(b) means for storing the letter of reference in a database.

7. A computer program product that includes a medium readable by a processor, the medium having stored thereon a set of instructions for a job recruiting system, comprising:
(a) a first sequence of instructions which, when executed by the processor, causes said processor to publish a job recruiting web site on the Internet;
(b) a second sequence of instructions which, when executed by the processor, causes said processor to accept at least one job posting from at least one job recruiter through said web site, the job posting including detailed job skills and experience required from a candidate;
(c) a third sequence of instructions which, when executed by the processor, causes said processor to publish the at least one job posting on the web site;
(d) a fourth sequence of instructions which, when executed by the processor, causes said processor to receive at least one candidate profile through said web site, including form questions regarding the candidate's skills and experience;
(e) a fifth sequence of instructions which, when executed by the processor, causes said processor to convey at least one prescreening question posed by the job recruiter to the candidate, including a requirement for a video response;
(f) a sixth sequence of instructions which, when executed by the processor, causes said processor to receive and store a video file from the candidate in response to the at least one prescreening question; and
(g) a seventh sequence of instructions which, when executed by the processor, causes said processor to transfer the video file to the job recruiter through the Internet as streaming video.

8. The computer program product according to claim 7, wherein said first set of instructions further includes:
(a) instructions which, when executed by the processor, cause said processor to publish a main web site on the Internet, said main web site accepting job postings from multiple employers and job recruiters, and for multiple job disciplines;
(b) instructions which, when executed by the processor, cause said processor to publish a corporate web site on the Internet, said corporate web site accepting job postings from multiple job recruiters within said corporation and accepting candidate profiles directly, said corporate web site having means for duplicating job postings onto said main web site and accessing candidate profiles stored in a main database maintained by said main web site; and
(c) instructions which, when executed by the processor, cause said processor to publish a niche web site on the Internet, said niche web site accepting job postings from multiple job recruiters within a particular job discipline and accepting candidate profiles directly, said niche web site having means for duplicating job postings onto said main web site and accessing candidate profiles stored in a main database maintained by said main web site.

9. The computer program product according to claim 7, further comprising:
(a) a set of instructions which, when executed by said processor, causes said processor to establish a message center server; and
(b) a set of instructions which, when executed by said processor, causes said processor to publish a message center client program downloadable from said web site in order to establish a message center client on a candidate's computer, said message center client program having a set of instructions including:
(i) instructions which, when executed by a processor, cause the processor to log into said message center server;
(ii) instructions which, when executed by a processor, cause the processor to detect audio and video recording devices attached to a candidate's computer;
(iii) instructions which, when executed by a processor, cause the processor to capture, compress, and upload video, audio, text, numeric and Boolean responses to a job recruiter's question to said message center server; and
(iv) instructions which, when executed by a processor, cause the processor to time the candidate's responses to the job recruiter's question.

10. The computer program product according to claim 7, further comprising a set of instructions including:
(a) instructions which, when executed by said processor, cause said processor to extract a candidate's responses to the form questions on said candidate's profile; and
(b) a criteria matching program having a set of instructions including:
(i) instructions which, when executed by said processor, cause said processor to compare the candidate's job skills responses to the job skills in the job posting;
(ii) instructions which, when executed by said processor, cause said processor to compute a percentage of matches between a candidate's job skills responses and the job skills required in the job posting; and
(iii) instructions which, when executed by said processor, cause said processor to compute a percentage of a candidate's overqualification.

11. The computer program product according to claim 7, further comprising a set of instructions including:
(a) instructions which, when executed by said processor, cause said processor to automatically request a letter of reference by electronic mail from a candidate's listed references on the candidate profile; and
(b) instructions which, when executed by said processor, cause said processor to store the letter of reference in a database.

12. A computerized method for job recruiting over the Internet, comprising the steps of:
(a) publishing at least one web site on the Internet;
(b) accepting at least one job posting from at least one job recruiter through said web site, the job posting including detailed job skills and experience required from a candidate;
(c) publishing the at least one job posting on the web site;
(d) receiving at least one candidate profile through said web site, including form questions regarding the candidate's skills and experience;
(e) conveying at least one prescreening question posed by the job recruiter to the candidate, including a requirement for a video response;
(f) receiving and storing a video file from the candidate in response to the at least one prescreening question; and
(g) transferring the video file to the job recruiter through the Internet as streaming video.

13. The computerized method for job recruiting according to claim 12, further comprising a step of establishing a main database for storing job postings and candidate profiles, said main database being accessible through said at least one web site.

14. The computerized method for job recruiting according to claim 13, wherein the step of publishing at least one web site further comprises:
(a) publishing a main web site on the Internet, said main web site accepting job postings from multiple employers and job recruiters, and for multiple job disciplines;
(b) publishing a corporate web site on the Internet, said corporate web site accepting job postings from multiple job recruiters within said corporation and accepting candidate profiles directly, said corporate web site having means for duplicating job postings onto said main web site and accessing candidate profiles stored in said main database; and
(c) publishing a niche web site on the Internet, said niche web site accepting job postings from multiple job recruiters within a particular job discipline and accepting candidate profiles directly, said niche web site having means for duplicating job postings onto said main web site and accessing candidate profiles stored in said main database.

15. The computerized method for job recruiting according to claim 12, further comprising the steps of:
(a) establishing a message center server; and
(b) publishing a message center client program downloadable from said web site in order to establish a message center client on a candidate's computer, said message center client program having:
(i) means for logging into said message center server;
(ii) means for detecting audio and video recording devices attached to a candidate's computer;
(iii) means for capturing, compressing, and uploading video, audio, text, numeric and Boolean responses to a job recruiter's question to said message center server; and
(iv) means for timing the candidate's responses to the job recruiter's question.

16. The computerized method for job recruiting according to claim 12, further comprising the steps of:
(a) extracting a candidate's responses to the form questions on said candidate's profile;
(b) comparing the candidate's job skills responses to the job skills in the job posting;
(c) computing a percentage of matches between a candidate's job skills responses and the job skills required in the job posting; and
(d) computing a percentage of a candidate's overqualification.

17. The computerized method for job recruiting according to claim 12, further comprising the steps of:
(a) automatically requesting a letter of reference by electronic mail from a candidate's listed references on the candidate profile; and
(b) storing the letter of reference in a database.
